(19) United States
(12) Patent Application Publication
(10) Pub. No.: US 2012/0036383 A1
(43) Pub. Date: Feb. 9, 2012

(54) POWER SUPPLY FOR NETWORKED HOST COMPUTERS AND CONTROL METHOD THEREOF

(75) Inventor: Tetsuki IWATA, Niiza-shi (JP)

(73) Assignee: Sanken Electric Co., Ltd., Niiza-shi (JP)

(21) Appl. No.: 13/205,014

(22) Filed: Aug. 8, 2011

(30) Foreign Application Priority Data
Aug. 9, 2010 (JP) 2010-178856

(51) Int. Cl. G06F 1/32

(52) U.S. Cl. 713/324

(57) ABSTRACT

A power supply is used in combination with networked first and second hosts with a virtual machine implemented on the first host. The power supply is comprised of: a memory; an outlet part linked with outlets respectively supplying electricity to the hosts; a communication interface linked with the hosts; a controller linked with the memory, the outlet part and the communication interface; a migration process located on the memory, wherein the migration process causes the communication interface to send a migration instruction to the first host, the migration instruction causing migration of the virtual machine to the second host; and a shut-down process located on the memory, wherein the shut-down process causes the communication interface to send a shut-down instruction to the first host, the shut-down instruction causing shut-down of the first host.

### CROSS-REFERENCE TO RELATED APPLICATIONS

This application is based upon and claims the benefit of priority from the prior Japanese Patent Application No. 2010-178856 (filed Aug. 9, 2010); the entire contents of which are incorporated herein by reference.

### BACKGROUND OF THE INVENTION

1. Field of the Invention

The present invention relates to a power supply for networked host computers and a method for controlling the power supply.

2. Description of the Related Art

A virtual machine (VM) is a software implementation of a computer virtually running on a host computer, which utilizes resources of the host but behaves like an individual computer. A plurality of VMs may be implemented on either a single host or a plurality of linked hosts. Execution of VMs on linked hosts is in general beneficial in more effectively utilizing resources of the hosts.

When VMs are implemented on linked hosts, any of the VMs may migrate from one host to another host on the same network. This procedure may be executed manually or automatically under control by a VM monitor.

### SUMMARY OF THE INVENTION

One or more hosts are sometimes required to be shut down in order to deal with certain situations such as a planned blackout or for the purpose of energy saving. Reasonable measures should be taken at a time of shut-down because otherwise processes running on VMs on the hosts at issue will be unintentionally lost. Required procedures are, however, laborious and troublesome as management of the VMs is separate from management of power supplies in the prior art. The present invention has been achieved to overcome this problem.

According to a first aspect of the present invention, a power supply used in combination with networked first and second hosts with a virtual machine implemented on the first host, is comprised of: a memory; an outlet part linked with outlets respectively supplying electricity to the hosts; a communication interface linked with the hosts; a controller linked with the memory, the outlet part and the communication interface; a migration process located on the memory, wherein the migration process causes the communication interface to send a migration instruction to the first host, the migration instruction causing migration of the virtual machine to the second host; and a shut-down process located on the memory, wherein the shut-down process causes the communication interface to send a shut-down instruction to the first host, the shut-down instruction causing shut-down of the first host.

According to a second aspect of the present invention, a method of control of a power supply used in combination with networked first and second hosts with a virtual machine implemented on the first host, is comprised of the steps of: allocating resources on the second host to the virtual machine; sending a migration instruction to the first host, the migration instruction causing migration of the virtual machine from the first host to the second host; and sending a shut-down instruction to the first host, the shut-down instruction causing shut-down of the first host.

### BRIEF DESCRIPTION OF THE DRAWINGS

FIG. 1 is a schematic diagram of a network with a plurality of hosts and power supplies in accordance with a first embodiment of the present invention.

FIG. 2 is a schematic diagram of the network, in which some VMs are migrated from one host to another host.

FIG. 3 illustrates the power supply.

FIGS. 4A and 4B illustrate data structures related to each power supply (FIG. 4A) and each VM (FIG. 4B).

FIG. 5 illustrates a data structure about a time schedule of shutdown.

FIG. 6 illustrates a data structure about a historical data of power consumption.

FIG. 7 illustrates a data structure about instructions issued to respective power supplies subject to shutdown.

FIG. 8 illustrates a data structure about instructions for the respective VMs at a time of the shutdown.

FIG. 9 illustrates a data structure about a relation between the hosts and the VMs.

FIG. 10 illustrates a data structure about optional instructions.

FIG. 11 illustrates a flowchart depicting a method of power management in accordance with the first embodiment.

FIG. 12 illustrates a flowchart depicting a procedure of power-off and reboot.

FIG. 13 illustrates a flowchart depicting a procedure of migration.

FIG. 14 illustrates a physical host on the network.

FIG. 15 illustrates a flowchart depicting a sequence around shutdown.

FIG. 16 illustrates a flowchart depicting a sequence around migration.

FIG. 17 illustrates a flowchart depicting a sequence around migration in accordance with a second embodiment.

FIG. 18 illustrates a power supply in accordance with the second embodiment, which manages a schedule.

FIG. 19 illustrates a flowchart depicting a method of power management of the power supply.

FIG. 20 illustrates a flowchart depicting a procedure of sending requests to respective power supplies.

FIG. 21 illustrates a power supply which does not manage a schedule.

FIG. 22 illustrates a flowchart depicting a method of power management of the power supply.

FIG. 23 illustrates a data structure about instructions issued to respective power supplies subject to shutdown in accordance with a third embodiment.

FIG. 24 illustrates a data structure about a relation between the hosts and the VMs.

FIG. 25 illustrates a flowchart depicting a procedure of power-off and reboot.

FIG. 26 illustrates a flowchart depicting a procedure of migration.

### DETAILED DESCRIPTION OF THE PREFERRED EMBODIMENT

Certain embodiments of the present invention will be described hereinafter with reference to the appended drawings.

Throughout the specification and claims, the term “host” means a host computer executable of one or more virtual machines (VMs) thereon. The host may be a physical host computer with an operation system as in a general construction, or alternatively the host for itself may be a virtual computer implemented on a physical computer.

The term “migration” means transfer of any physical or virtual entities such as data or VMs between two infrastructures such as storages or computers. Description given hereafter will mainly deal with migration of VMs.

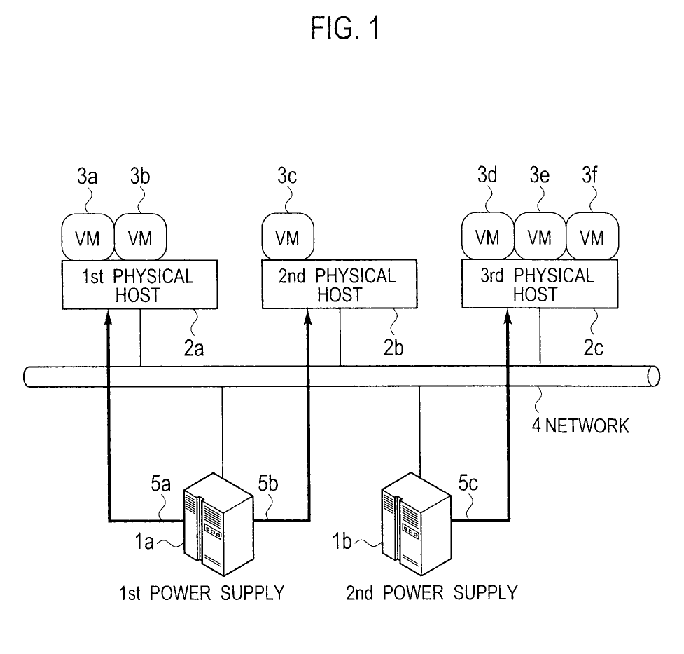

Referring to FIG. 1, a system with power supplies in accordance with a first embodiment of the present invention will be described hereinafter. The system is in general comprised of power supplies 1, host computers 2, virtual machines (VMs) 3 running on the hosts and a network 4 with which the power supplies and the hosts are commonly linked. In the example illustrated in FIG. 1, there exist two power supplies 1a, 1b, and three hosts 2a, 2b and 2c with six VMs 3a, 3b, 3c, 3d, 3e and 3f running thereon. Of course the numbers of the respectively elements are arbitrary.

Not only do power supplies 1 supply electricity to hosts 2, but also execute processes in conjunction with power management in the system. The processes executed by the power supply 1 include: 1) to control shutdown of hosts and VMs running on the hosts; 2) to control migration of VMs; and 3) to send and receive commands and data to and from the hosts and the VMs. These processes may be executed either on schedule or in case of unforeseeable emergency.

The first power supply 1a is comprised of a first outlet 5a for supplying electricity to the first host 2a and a second outlet 5b for supplying electricity to the second host 2b, and the second power supply 1b is comprised of a third outlet 5c for supplying electricity to the third host 2c, for example. Arrows with thick lines in the drawings schematically show flow of power supply.

The hosts 2 have ordinary computer construction with proper OS capable of having one or more VMs running thereon. The hosts 2 receive power supply through the outlets 5 of the power supplies 2.

On the first host 2a running are the first VM 3a and the second VM 3b, on the second host 2b running is the third VM 3c, and on the third host 2c running is the fourth to sixth VMs 3d, 3e and 3f, at this state.

Construction of the network 4 can be a so-called local area network (LAN) but any other construction may be applicable thereto.

First described hereinafter is a case where the second power supply 1b is shut down according to a predetermined schedule.

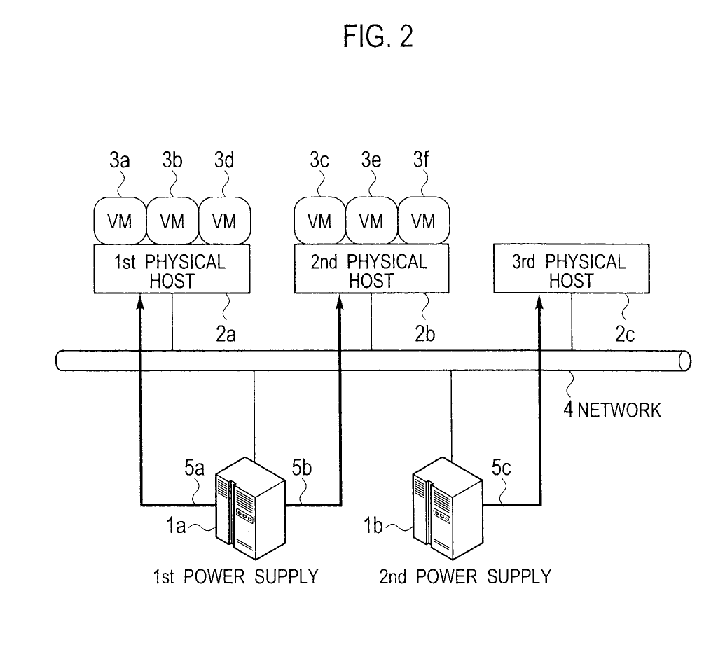

The second power supply 1b, before shutdown, executes VM migration control to migrate the VMs 3d, 3e, 3f from the third host 2c to the first and second hosts 2a, 2b. FIG. 2 illustrates a state after the VM migration in which the first, second and fourth VMs 3a, 3b, 3d run on the first host 2a, the third, fifth and sixth VMs 3c, 3e, 3f run on the second host 2b, and no VM exists on the third host 2c.

Then the second power supply 1b can shut down the third host 2c without stopping any processes on the system and can thereafter shut down itself. As one of the power supplies is shut down, overall energy consumption can be saved.

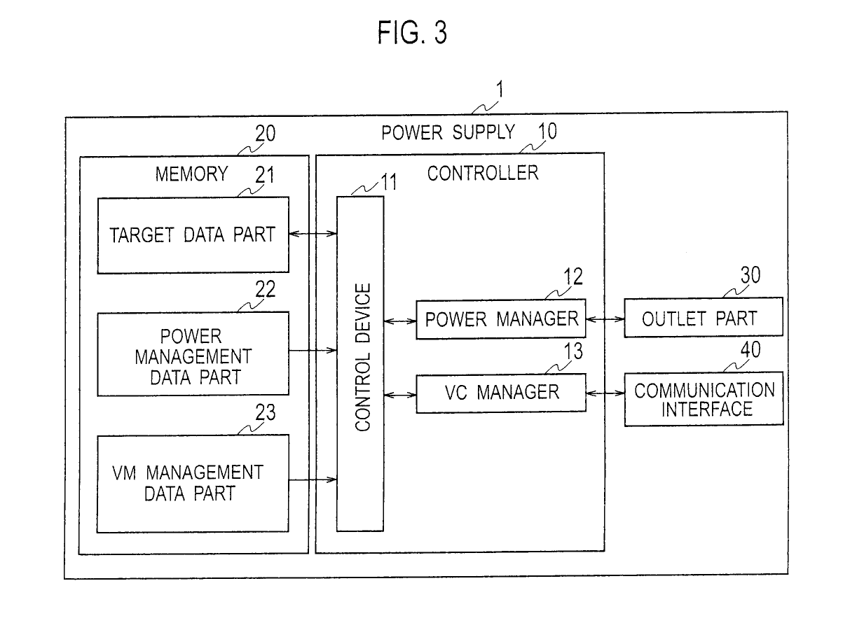

Referring to FIG. 3, the power supply 1 will be described in further detail. The power supply 1 is comprised of a controller 10, a memory 20, an outlet part 30, and a communication interface 40.

The outlet part 30 is preferably comprised of one or more outlets for coupling with hosts to supply electricity. The communication interface 40 is a proper interface for establishing communication with digital equipments on the network, such as a LAN adapter.

The memory 20 stores a firmware program for the power supply 1, a control program for communication, shutdown and such, and data for being used in the control program. The memory 20 includes a plurality of memory areas for respectively storing fractions of the data. These memory areas may include a target data part 21, a power management data part 22, and a VM management data part 23. Any of these parts are not necessarily resident in the memory 20 and may be resident in any external resources.

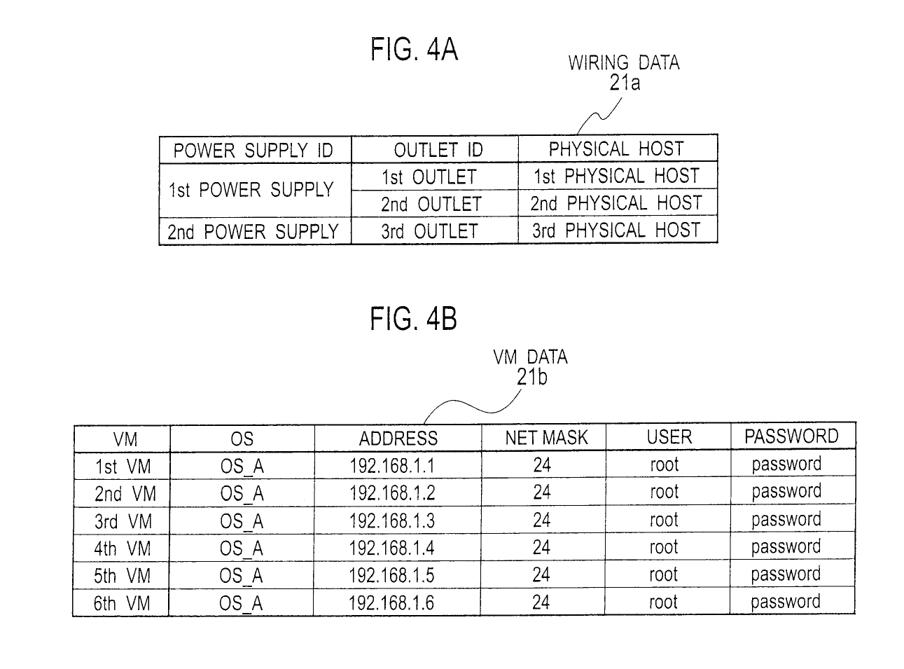

The target data part 21 stores wiring data 21a about how power cables are connected and VM data 21b about how the respective VMs 3 get on the network 4. Data structures of the wiring data 21a and the VM data 21b will be described in detail with reference to FIGS. 4A and 4B.

Referring to FIG. 4A, the wiring data 21a includes information about wiring of the power cables, which are preferably grouped according to the respective outlets. In the illustrated wiring data 21a, each outlet is tagged with a typical power supply identifier (ID) and a typical outlet ID, and a host connected to the outlet is related to these IDs.

Referring to FIG. 4B, the VM data 21b includes information required to connect the respective VMs 3 with the network 4, which are preferably grouped according to the respective VMs 3. In the illustrated VM data 21b, each VM is tagged with a typical VM ID, and a name of OS, an IP address, a net mask, a user, and a password for login are related thereto.

The power management data part 22 stores power supply data 22a, historical data 22b, and instruction data 22c.

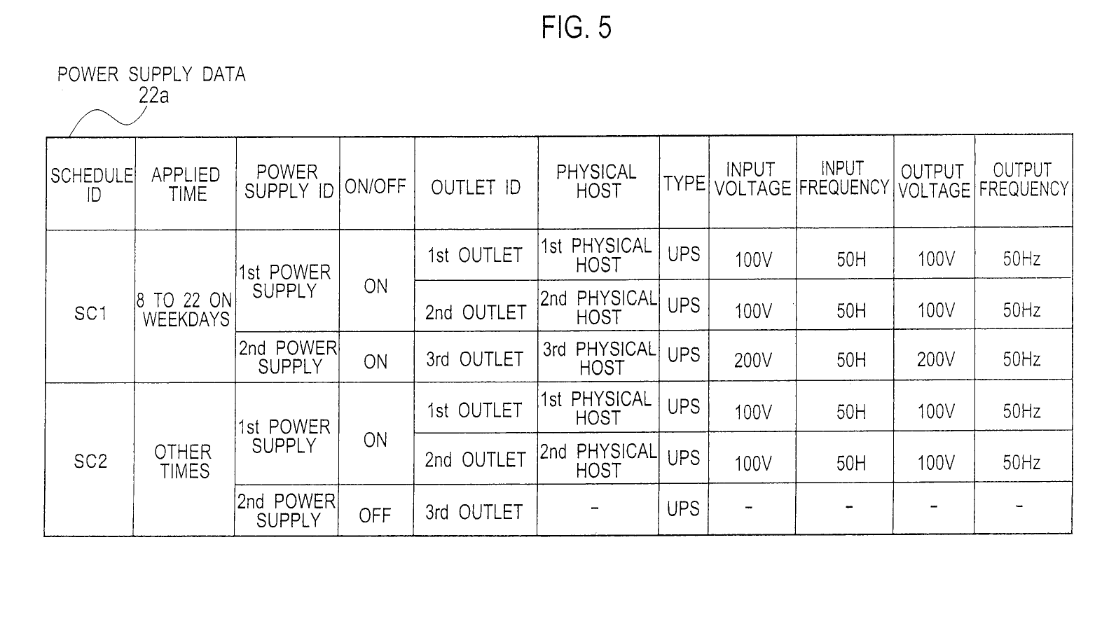

The power supply data 22a concern how to control power-on/off of the respective hosts in accordance with a predetermined schedule. Referring to FIG. 5, in the power supply data 22a, each schedule is tagged with a schedule ID. In accordance with each schedule ID, an applied time, identifications of power supplies, identifications whether the power supplies are power-on/off, outlet IDs, host IDs, types of power supplies, and input/output power voltages/frequencies are related thereto.

Applied time varies in accordance with the schedules and is specified in the column “APPLIED TIME”. In the illustrated power supply data 22a, the schedule SC1 applies to 8 to 22 on weekdays and the schedule SC2 applies to the other times.

The column “ON/OFF” records flags determining whether the power supplies are shut down or powered on. The columns “OUTLET ID” and “PHYSICAL HOST” record how the respective outlets are connected with the respective hosts. Further each line records a type of the power supply and its input voltage, frequency, output voltage and output frequency.

In the schedule SC2 in the drawing, the second power supply 1b is scheduled to be shut down and thus operation conditions are not required to be specified. Thus the line at issue in the columns “HOST”, “INPUT VOLTAGE”, “INPUT FREQUENCY”, “OUTPUT VOLTAGE” and “OUTPUT FREQUENCY” does not specify any data.

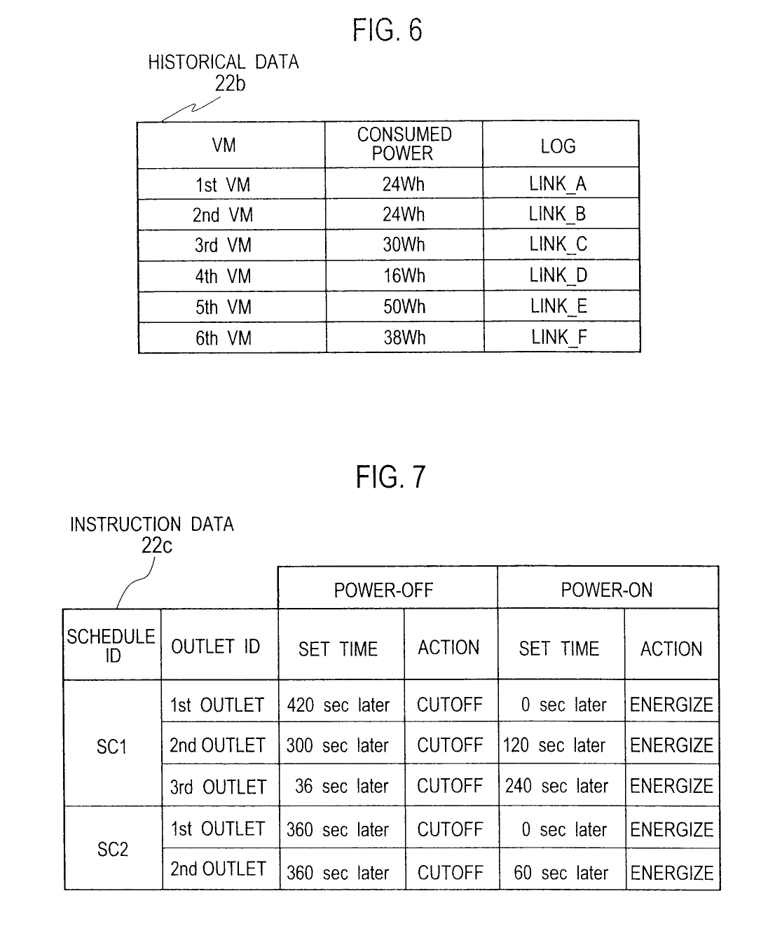

The historical data 22b concern power consumption histories of the respective VMs 3. Referring to FIG. 6, consumed powers in the past and these logs are related to the respective VMs. More detailed data about power consumptions may be recorded at areas indicated in the logs. The data may be utilized to estimate how was energy saving about the respective VMs.

The instruction data 22c concern how to operate processes of shutdown and power-on. Referring to FIG. 7, set times and actions (cut off or energize) are related to the schedule IDs and the outlet IDs. For example, in the schedule SC1, electricity through the first outlet 5a is cut off 420 seconds later after a scheduled shutdown time and the first outlet 5a is energized again 0 second later after a scheduled energizing time.

The VM management data part 23 stores instruction data 23a about how to control the respective VMs 3 around shutdown and power-on, instruction data 23b about resources of the respective VMs 3, and arbitrary instruction data 23c.

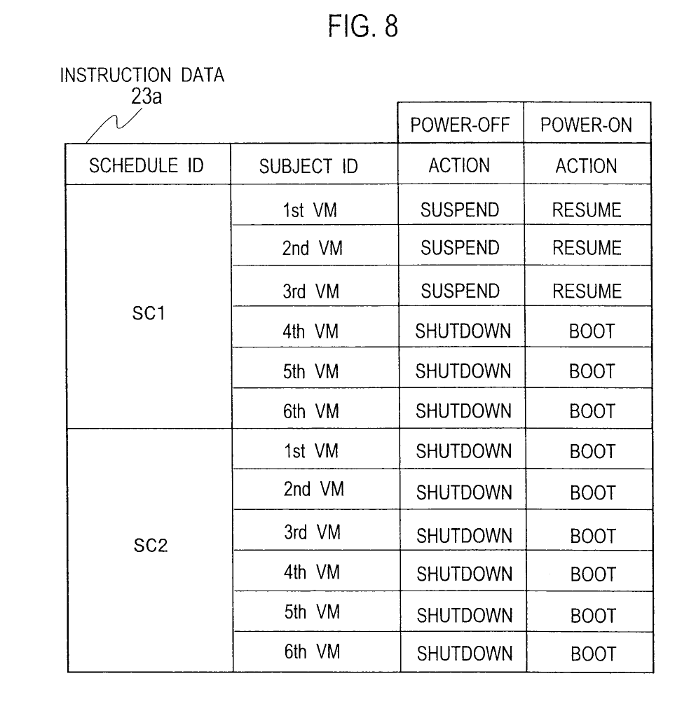

Referring to FIG. 8, in the instruction data 23a, actions (to suspend or shut down the VM) at the time of power-off and actions (to resume or boot the VM) are related to the schedule IDs and subject IDs which identify VM subject to control. Each subject ID identifies any one of the VMs 3.

The instruction data 23b concern VM migration control.

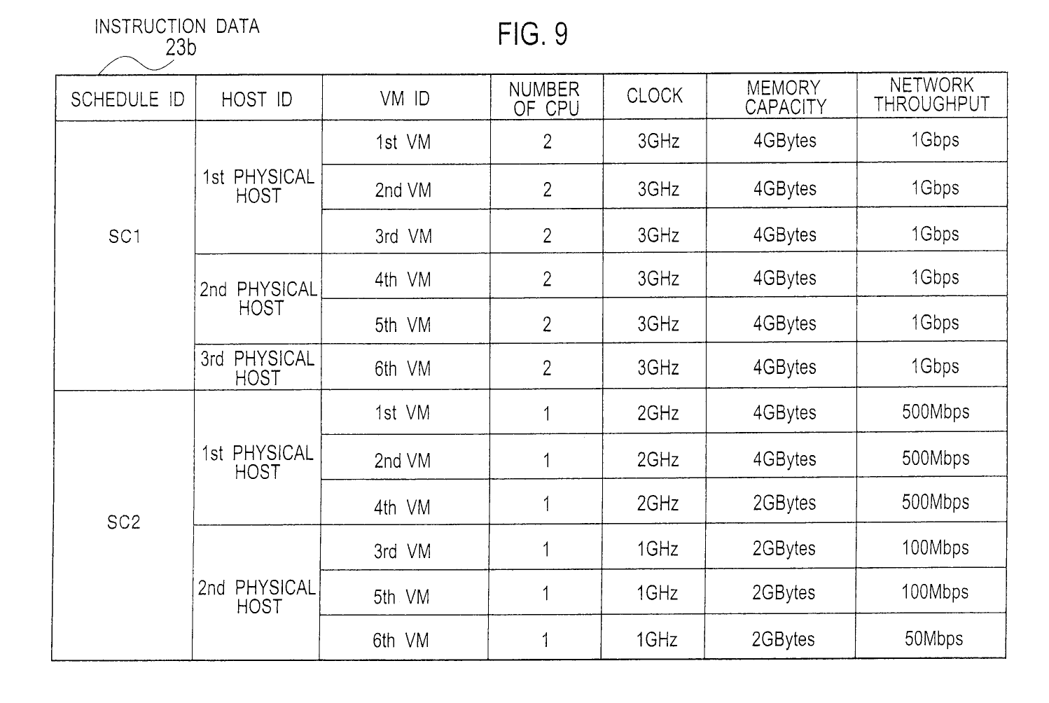

Referring to FIG. 9, in the instruction data 23b, resources such as the number of CPU, the clock, the memory capacity and the network throughput are related to each VM on the basis of a state after migration. The data 23b may further contain data about configurations about communication.

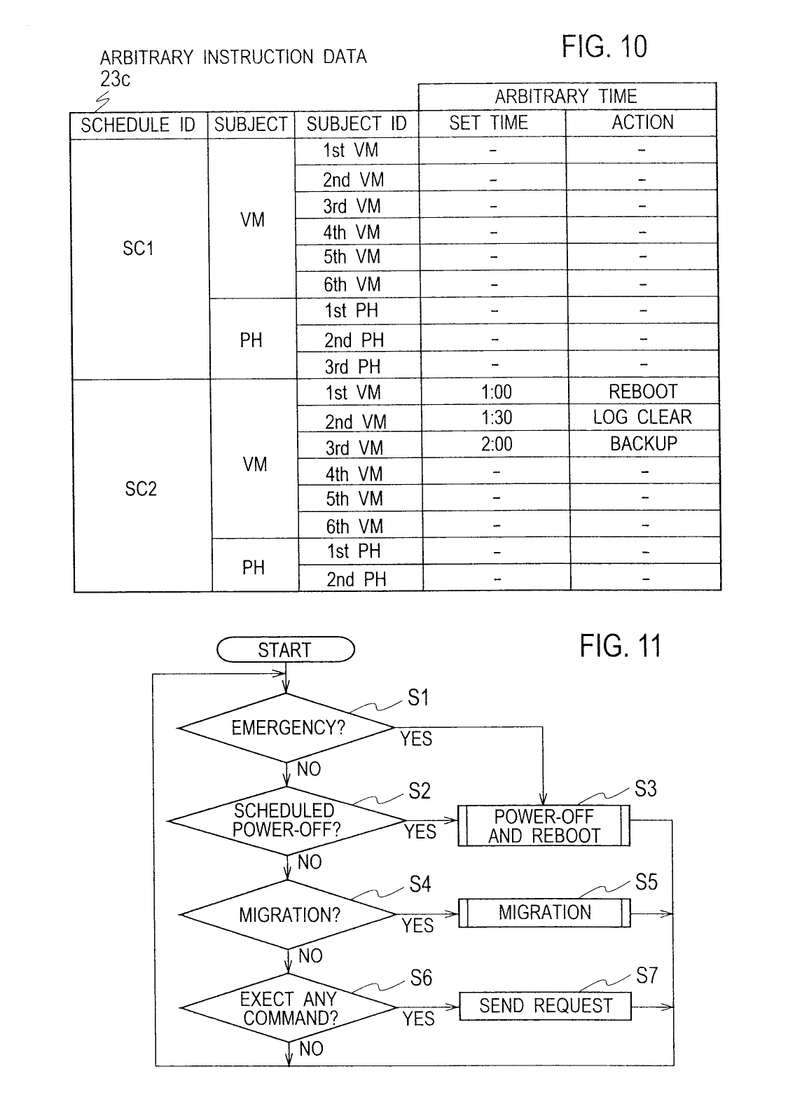

The arbitrary instruction data 23c concern events which occur at arbitrarily set times. Referring to FIG. 10, in the arbitrary instruction data 23c, set times and related actions are related to the respective VMs.

As being understood from the above description, the memory 20 of the first power supply 1a stores not only data about itself and the VMs under its control but also all the data related to the other power supply 1b (and other power supplies 1c, 1d . . . , 1f exist). This construction saves data traffic on the network 4 but the power supplies 1 nevertheless share common data. Of course, it may be modified so that each power supply stores data only about itself. Alternatively, it may be modified so that the network 4 has an external storage storing all the data so as to allow all the power supplies 1 to read the data via the network 4.

The controller 10 is comprised of a control device 11 including computing resources such as a CPU, a memory I/O, a bus controller and such, which is operated by a proper program including a firmware. The control device 11 establishes link with the respective parts 21, 22, 23 in the memory 20 to read out the data therein and also write renewed data according to results of operation. The wiring data 21a and the VM data 21b stored in the target data part 21 are mainly subject to data renewal as described later but the other parts are also capable of being rewritten.

The controller 10 further comprises a power manager 12 and a VM manager 13, both of which establish link with the control device 11 to receive and send commands.

The outlet part 30 controllably supplies electricity to the respective hosts 2. The power manager 12 is linked with the outlet part 30 as well as the control device 11. The power manager 12 under control by the control device 11 manages power supply from the outlet part 30 to the respective hosts 2.

The communication interface 40 is so linked with the network 4 to communicate with the hosts 2 as well as the VMs 3 running thereon. Via the communication interface 40, the VM manager 13 under control by the control device 11 sends and receives requests and notices to and from the hosts 2 as well as the VMs 3, thereby managing shutdown, boot and migration of the hosts 2 and the VMs 3.

The aforementioned elements may be housed in a single chassis of the power supply 1 at issue but alternatively may be housed in a plurality of separate chassis.

Referring to FIG. 11, the control device 11 of the power supplies 1 executes the following process.

First the control device 11 in the step S1 determines whether any emergency event which requires shutdown occurs or not. Being struck by lightning or such may be one of such emergencies for example. If YES, the control device 11 executes a power-off and reboot process S3, details of which will be described later.

If it is determined to be NO in the step S1, the control device 11 in the step S2 determines whether an event of scheduled power-off occurs or not. If YES, the control device 11 executes the power-off and reboot process S3.

If it is determined to be NO also in the step S2, the control device 11 in the step S4 determines whether an event requiring migration of one or more VMs occurs or not. If YES, the control device 11 executes a migration process S5, details of which will be described later.

If it is determined to be NO in the step S4, the control device 11 in the step S6 determines whether it needs to execute any other command or not. If YES, the control device 11 executes sending requests S7 to execute the command through the communication interface 40. Otherwise, or after finishing any of the steps S3, S5 and S7, operation returns to the step S1.

The aforementioned operation may include processes triggered by an interrupt. Then the control device 11 may executes any of the steps S3, S5 and S7 or other processes in accordance with the interrupt request.

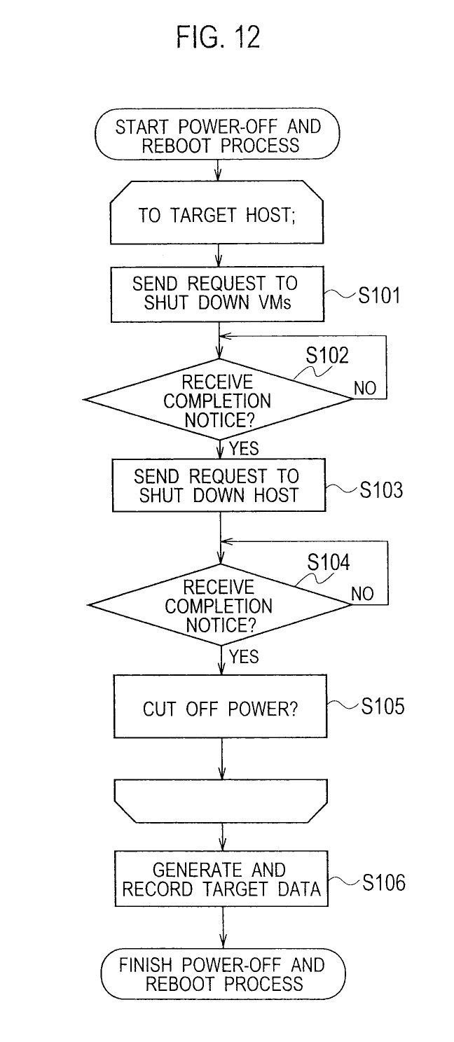

Referring to FIG. 12, the power-off and reboot process S3 will be described in detail.

First the control device 11 in the step S101 causes the VM manager 13 to send requests (to shut down, or, in particular cases, to suspend the target VM) in accordance with the actions defined in the instruction data 23a to the respective VMs 3 through the communication interface 40 in accordance with the wiring data 21a and the VM data 21b.

The control device 11 in the step S102 waits to finish receiving notices of process completion from all the VMs 3, and thereafter the operation goes to the step S103.

The control device 11 in the step S103 causes the VM manager 13 to send requests to shut down or suspend the hosts 2 to the respective hosts 2 through the communication interface 40. The control device 11 in the step S104 waits to finish receiving notices of process completion from all the hosts 2.

After finishing the steps 101 through 104, the control device 11 in the step S105 causes the power manager 12 to control the outlet part 30 to cut off power supply to the hosts 2 in accordance with the instruction data 22c.

Subsequently the control device 11 in the step S106 checks up the latest state about the hosts 2 and the VMs 3 of the target of the management and, based thereon, generates target data including renewed wiring data 21a and VM data 21b. The control device 11 records the generated data in the target data part 21 of the memory 20.

While the above description mentions merely a sequence about shutdown, a sequence about reboot can be executed in the same way.

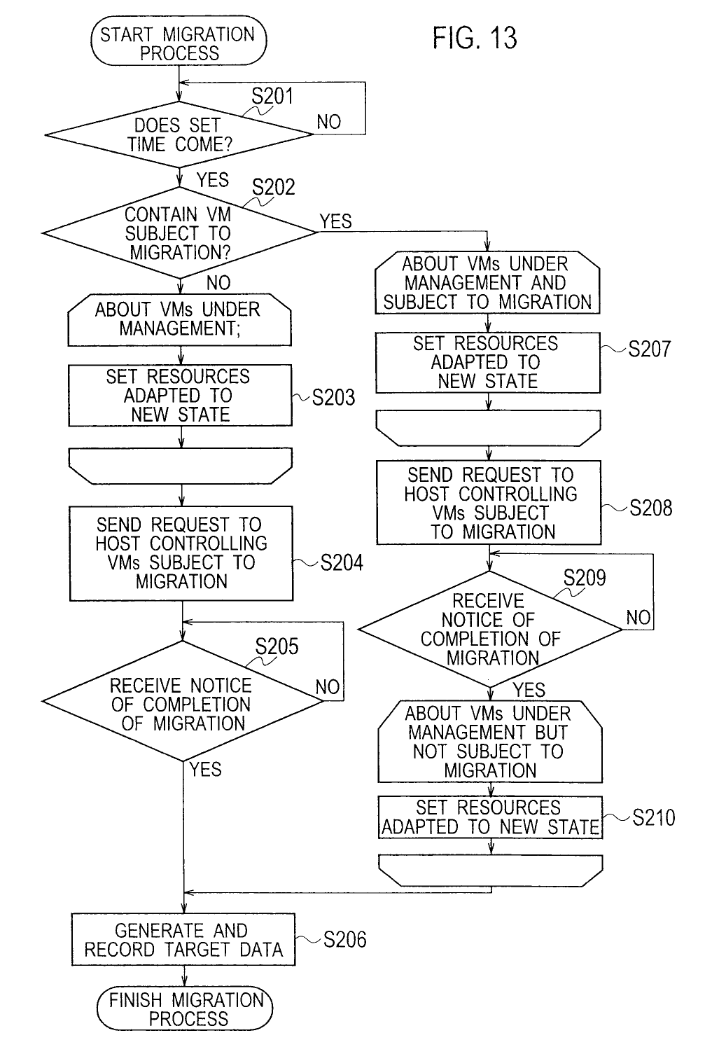

Referring to FIG. 13, the migration process S5 will be described in detail. The following description is given on the assumption that the system is first in a state shown in FIG. 1 where the fourth VM 3d runs on the third host 2c and then the fourth VM 3d is made to migrate to the first host 2a.

First the control device 11 in the step S201 refers the data in the power management data part 22 and the VM management data part 23 to determine whether set time for migration comes or not. If YES, the control device 11 in the step S202 further determines whether VMs under its management contain VMs subject to migration or not.

IF NO in the step S202, the control device 11 in the step S203 inputs an instruction to the VM manager 13, which is to set resources adapted to the new state after migration about all the VMs under its management. Based on the instruction, the VM manager 13 sends instructions to the respective hosts 2 powered by the power supply 1 at issue through the communication interface 40.

In this example, the VM 3d is scheduled to migrate to the first host 2a and therefore allocation of resources on the first host 2a to the VM 3d should be managed, while the VMs 3a, 3b are still on the first host 2a. Some part of resources on the host 2a is already allocated to the VMs 3a, 3b and the left is freely allocatable. Thus there are in general two alternatives that the system should select, in one of which some of the left resources is allocated to the VM 3d newly running on the host 2a, and in another of which the resources are totally re-allocated to the VMs 3a, 3b, 3d. The former may be beneficial in retaining performance of the VMs 3a, 3b but a proper configuration may cover performance degradation caused by the latter. Which is selected depends on the software configuration.

The control device 11 of the first power supply 1a calculates resource allocation adapted to the new state and sends the instruction including resultant renewed resource information to the VM manager 13. Alternatively, the second power supply 1b or any host on the network may instead bear calculation of the resource allocation. The VM manager 13 sends the instruction including the new resource information to the first host 2a through the communication interface 40. The first host 2a receives the instruction and changes resource allocation in accordance with the received instruction.

The control device 11 subsequently in the step S204 sends a migration request to the first host 2a to which the VM 3d is to migrate. The request includes a VM ID assigned to the VM 3d subject to migration and a host ID assigned to the first host 2a to which the VM 3d migrates. The migration request is also sent to the third host 2c where the VM 3d currently runs.

The control device 11 subsequently in the step S205 waits to receive a notice of completion of migration. This notice will be sent from either the first host 2a of a destination of the migration or the third host 2c from which the VM migrates.

After receiving the notice, the control device 11 in the step S206 checks up the latest state about the hosts 2 and the VMs 3 and then generates target data including renewed wiring data 21a and VM data 21b. The control device 11 records the generated data in the target data part 21 of the memory 20.

IF YES in the step S202, operation goes to the steps S207-S210 and thereafter the step S206 is executed. The control device 11 in the step S207 inputs an instruction to the VM manager 13, which is to set resources adapted to the new state after migration about all the VMs under its management and also subject to migration. Based on the instruction, the VM manager 13 sends instructions to the hosts 2 having the VMs 3 subject to migration running thereon through the communication interface 40.

In this example, the fourth VM 3d is running on the third host 2c and is scheduled to migrate to the first host 2a. Thus resources on the third host 2c allocated to the fourth VM 3d should be released and then the fourth VM 3d will use the newly allocated resources on the first host 2a. The control device 11 of the second power supply 1b in the step S207 fetches information about resources to be allocated in the new state, and sends the instruction including resultant renewed resource information to the VM manager 13 of the second power supply 1b. The VM manager sends the instruction including the new resource information to the third host 2c through the communication interface 40. The third host 2c receives the instruction and changes resource allocation in accordance with the received instruction.

The control device 11 subsequently in the step S208 sends a migration request to both the first host 2a and the third host 2c as with the step S204.

The control device 11 in the step S209 waits to receive a notice of completion of migration. This notice will be sent from either the first host 2a or the third host 2c.

After receiving the notice, the control device 11 in the step S210 inputs an instruction to the VM manager 13, which is to set the resources after migration about the VMs 3 not subject to migration. Based on the instruction, the VM manager 13 sends instructions to the respective hosts 2 having the VMs 3 not subject to migration running thereon.

In this example, the fifth VM 3e and the sixth VM 3f are not scheduled to migrate to the other host while the fourth VM 3d running on the identical host 2c is scheduled to migrate to the first host 2a. As the resources allocated to the fourth VM 3d will be released, the fifth VM 3e and the sixth VM 3f can get renewed resources. The control device 11 of the second power supply 1b in the step S210 fetches information about resources to be allocated in the new state, and sends the instruction including resultant renewed resource information to the VM manager 13 of the second power supply 1b. The VM manager 13 sends the instruction including the new resource information to the third host 2c through the communication interface 40. The third host 2c receives the instruction and changes resource allocation of the fifth VM 3e and the sixth VM 3f in accordance with the received instruction.

The control device 11 subsequently in the step S206 checks up the latest state about the hosts 2 and the VMs 3 and then generates target data including renewed wiring data 21a and VM data 21b. The control device 11 records the generated data in the target data part 21 of the memory 20.

In the meantime, either the step S204 or the step S208 may be omitted as it may be sufficient if at least one of the power supply sends a migration request. Further, either the step S203 or the step S207 may be omitted in certain cases, for example in a case where resources will not be changed.

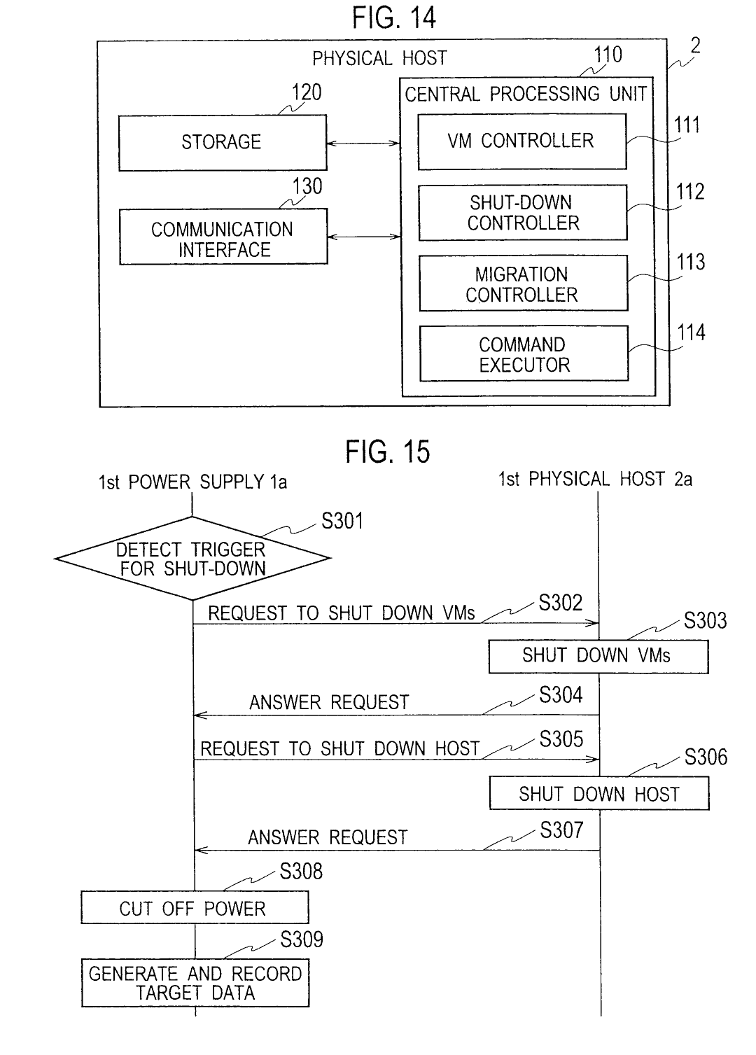

Referring to FIG. 14, each host 2 is, not deviated from an ordinary computer, comprised of a central processing unit 110, a storage device 120 and a communication interface 130 with a host OS installed therein. The central processing unit 110 may be comprised of multiple cores or multiple units. The storage device 120 may be similarly comprised of multiple storage devices, or may be shared with the other devices.

The central processing unit 110 is comprised of a VM controller 111, a shut-down controller 112, a migration controller 113, and a command executor 114, all of which may be either physical devices or virtual devices emulated by a software in combination with the installed OS.

The VM controller 111 controls VMs 3 running on the hosts 2 and resource allocation for the VMs 3.

The shut-down controller 112 controllably shut down the VMs 3 and the host 2 of itself in response to shut-down requests issued by any of the power supplies 1.

The migration controller 113 controls migration of a VM 3 running on the host 2 of itself to the other host.

The command executor 114 executes commands issued by any of the power supplies 1 and sends execution results in return. The command executor 114 for example receives commands to fetch a log about a VM and in return sends a log data of the VM.

The storage device 120 is a storage medium such as a hard disk to store data for operation as well as the OS and the software.

The communication interface 130 is a proper interface for establishing communication with digital equipments such as the other hosts, the power supplies and shared disks on the network, such as a LAN adapter or a fiber-channel SAN (FC-SAN).

Referring to FIG. 15, operation of the power supply 1a and the first host 1a at a time of cut-off power supply will be described. In the following description, power supply from the first power supply 1a to the first host 2a is cut off but the described operation can be applied to any combination.

In this example, a schedule is predetermined and the power supply 1a is based on the given schedule to execute power management and control of VCs. Further in this example, while the second power supply 1b supply electricity to the third host 2c, the fourth through sixth VMs 3d, 3e, 3f running on the third host 2c are, as shown in FIG. 2, made to migrate to the other hosts and then the third host 2c is shut down in advance of shutting down the second power supply 1b. This operation is executed under instructions issued by the first power supply 1a and the second power supply 1b.

First the first power supply 1a in the step S301 detects a trigger for shut-down. Being struck by lightning or a schedule of power cut-off may be a trigger. Successively the first power supply 1a fetches machine IDs subject to shut-down and actions (to suspend or shut down) related thereto from the instruction data 23a.

The first power supply 1a in the step S302 sends a request to shut down VMs to the first host 2a in accordance with the fetched information. The request includes the subject IDs and the actions.

The first host 2a in response in the step S303 shut down (or suspend) the VMs 3 running on the first host 2a in accordance with the content of the request. When finishing the shut-down step, the first host 2a in the step S307 sends a notice of process completion to the first power supply 1a. The notice may include the IDs corresponding to the VMs that are shut down.

In response to receipt of the notice of the process completion from the first host 2a, the first power supply 1a in the step S305 sends a request to shut down the first host 2a to the first host 2a.

The first host 2a in response in the step S306 shuts down itself and then in the step S307 answers the request.

As the first power supply 1a receives a notice of the process completion from the first host 2a, the first power supply 1a in the step S308 cuts off power to the first host 2a. In the step S308, a proper time delay before cut-off may be provided as defined in the instruction data 22c for example.

Subsequently the first power supply 1a in the step S309 checks up the latest state about the hosts 2 and the VMs 3 and then generates target data including renewed wiring data 21a and VM data 21b. The renewed data are recorded in the target data part 21 of the memory 20.

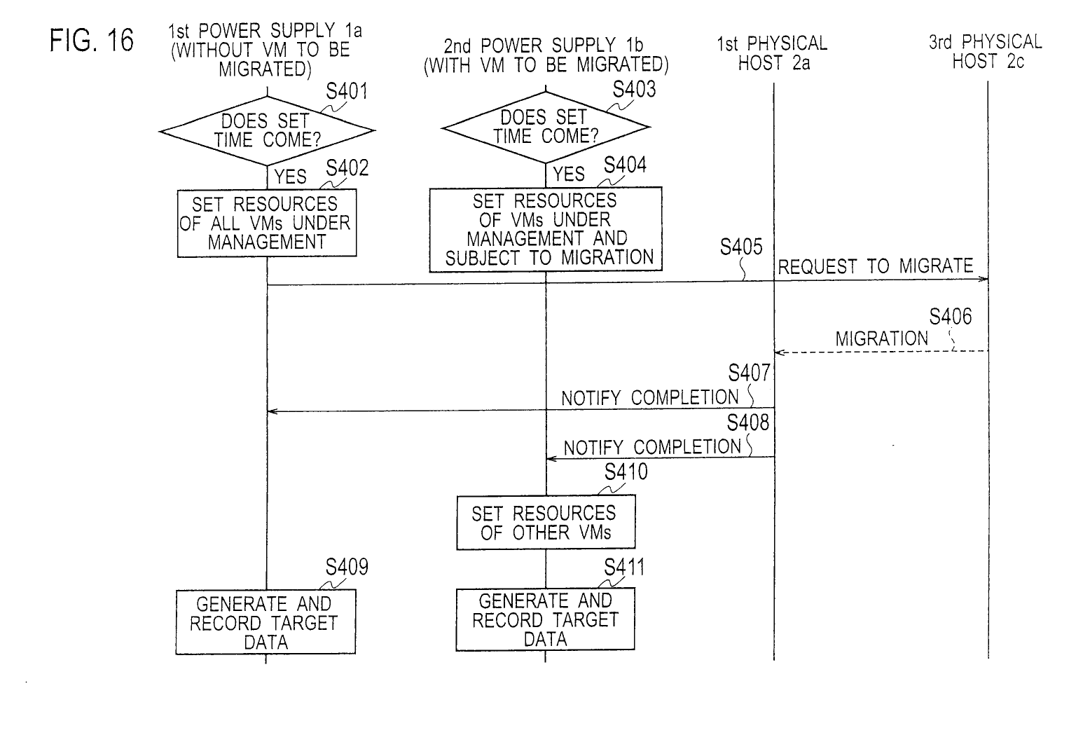

Referring to FIG. 16, operation of the power supplies 1 and the hosts 2 at a time of migration will be described. In the following description, the fourth VM 3d migrates from the third host 2c to the first host 2a but the described operation can be applied to any combination. The first and second power supplies 1a, 1b and the first and third hosts 2a, 2c take part in the operation.

At an initial state as shown in FIG. 1, the first power supply 1a supplies electricity to the first host 2a, on which any VMs, will not migrate out and the second power supply 1b supplies electricity to the third host 2c, on which the fourth VM 3d subject to migration and the fifth and sixth VMs 3e, 3f not subject to migration are running. The first and second power supplies 1a, 1b both in advance store schedules of the power management and the migration.

First the first power supply 1a in the step S401 verifies the schedules and, when it is determined to be a set time for migration, the first power supply 1a in the step S402 sets resources adapted to the new state in regard to all the VMs under its management, where the VMs under its management are the VMs 3a, 3b running on the first host 2a. The first power supply 1a may, before executing migration of the fourth VM 3d, release part of resources allocated to the first VM 3a and the second VM 3b so as to reallocate this part to the fourth VM 3d in this step.

The second power supply 1b in parallel in the step S403 verifies the schedules to determine that it comes the set time for migration and then in the step S404 sets resources adapted to the new state in regard to the fourth VM 3d.

The step S401 and the step S403, as well as the step S402 and the step S404, are not required to be synchronized as the both the power supplies 1a, 1b commonly have the schedule data.

After the step S402 and the step S404, the first power supply 1a (or instead the second power supply 1b) in the step S405 sends a request for migration to the host 2c as the host 2c has the fourth VM 3d subject to migration running. The request includes a VM ID assigned to the fourth VM 3d and a host ID assigned to the first host 2a as a destination of the migration.

The third host 2c in the step S406 receives the migration request and then executes migration of the fourth VM 3d to the first host 2a.

Thereafter the first host 2a in the step S407 sends a notice of completion of migration to the first power supply 1a and in the step S408 sends a notice of completion of migration to the second power supply 1b.

After receiving the notice, the first power supply 1a in the step S409 checks up the latest state about the hosts and the VMs 3 and then generates target data. The generated data is recorded in the target data part 21 of the memory 20 of the first power supply 1a.

In parallel the second power supply 1b in the step S410 sets resources adapted to the new state in regard to all the VMs but the VM 3d subject to migration. The second power supply 1b in the step S411 records renewed target data in the target data part 21 of the memory 20 of the second power supply 1b.

As will be understood from the above description, the power supply 1 executes management of VMs, which may be a function of a VM monitoring server in the prior art. Thus the power supply 1 can execute power-off and power-on operation in conjunction with VM management. The power supply 1 can for example stop power supply to hosts while any VMs running thereon are prevented from unintentionally going down, therefore the present embodiment provides high reliability.

The present embodiment is beneficial in saving energy. Workloads on the computer cluster vary from time to time. The power supply of the present embodiment can carry out dynamic control of computational resources in accordance with workload variation, in which all the usable host computers are booted up in a busiest time of day and some hosts are automatically shut down in a time with relatively light workloads, for example. This leads to optimization of energy consumption in view of workloads and thus it is energy-saving.

Whereas the shut-down schedule is, in the above description, given as a prepared data file, the schedule may be instead dynamically given to the system via a proper console for example.

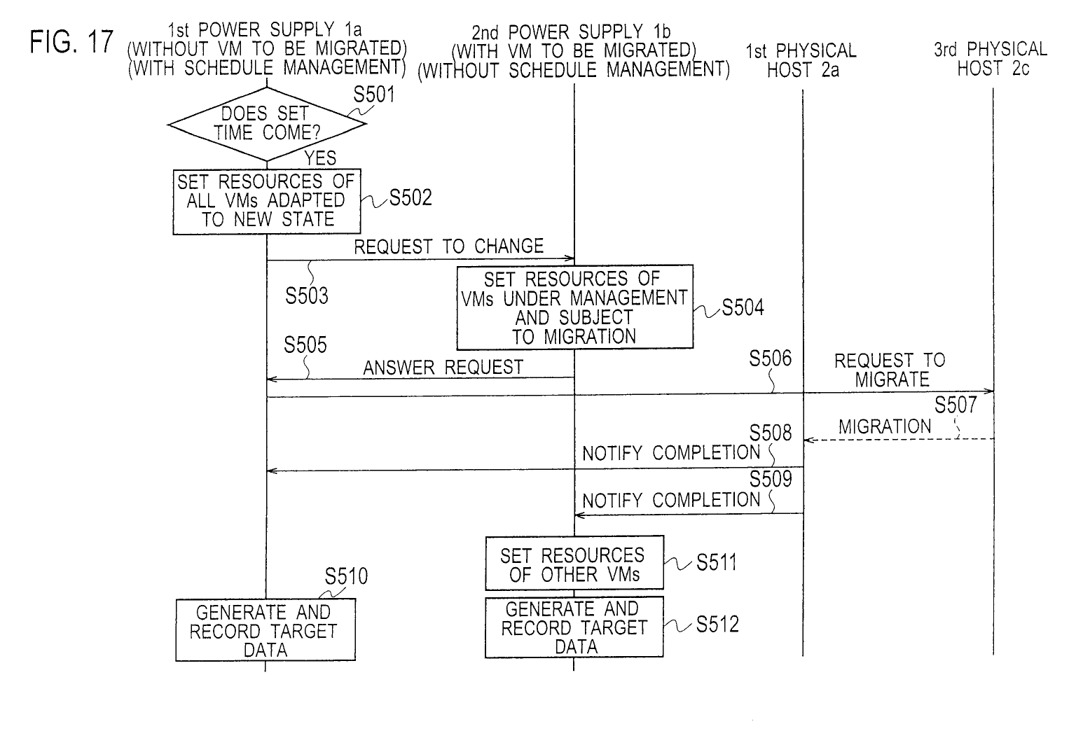

The embodiment described above may be modified in various ways. FIGS. 17 through 22 exemplify a second embodiment as one of such modifications.

In the present embodiment, not all but part of power supplies stores data of a schedule of power management and VC migration. More specifically, the following description is given on the assumption that the system is first in a state shown in FIG. 1 where the fourth VM 3d runs on the third host 2c and then the fourth VM 3d is made to migrate to the first host 2a under cooperative processes of the power supplies 1a, 1b and the hosts 2a, 2c while the first power supply 1a has schedule data but the second power supply 1b does not.

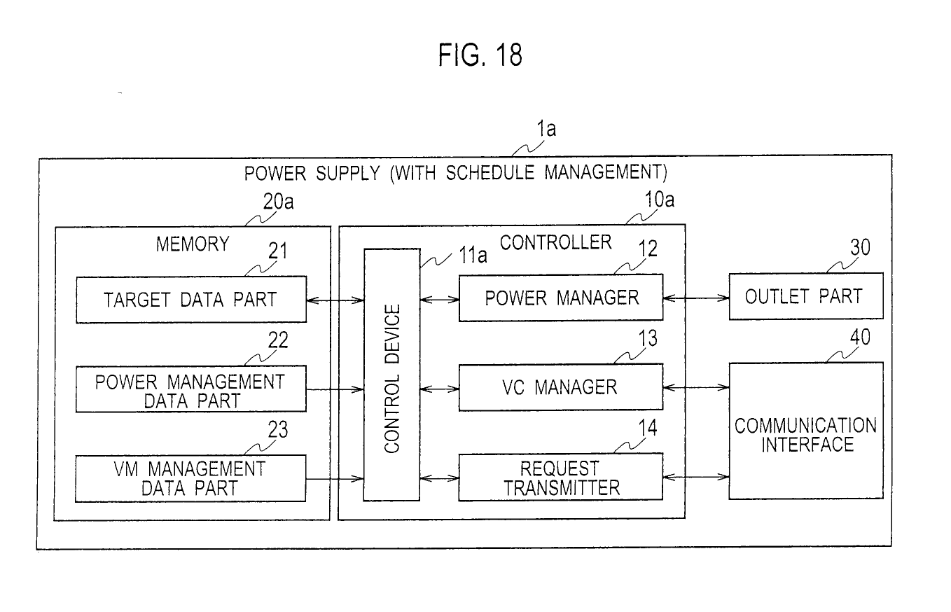

Referring to FIG. 18, a first power supply 1a according to the second embodiment, which manages schedule data, is comprised of a controller 10a, a memory 20a, an outlet part 30, and a communication interface 40, as with the power supply 1 shown in FIG. 3. The first power supply 1a is further, as compared with the power supply 1 shown in FIG. 3, comprised of a request transmitter 14 as part of the controller 10a. The request transmitter 14 under control by the control device 11a sends and receives requests and notices about resource change through the communication interface 40.

The control device 11a fetches not only data about VMs under control of the first power supply 1a from the memory 20 but also data about VMs under control by the other power supplies, such as the fourth through sixth VMs 3d, 3e, 3f under control by the second power supply 1b. The control device 11a inputs the latter data to the request transmitter 14.

Via the communication interface 40, the request transmitter 14 under control by the control device 11a sends and receives requests and notices about resource change to and from the other power supplies which do not have schedule data. The requests include machine IDs of VMs subject to migration, host IDs as destination of the migration, and information about resources to be allocated to the migrated VMs. Further the requests include machine IDs of VMs not subject to migration and information about resources allocated to the not-migrated VMs.

Referring to the FIG. 21, a second power supply 1b according to the second embodiment, which does not manage the schedule data, is comprised of a controller 10b, a memory 20b, an outlet part 30, and a communication interface 40, as with that described above. The memory 20b comprises only a target data part 21. The second power supply 1b, as not having schedule data within, works with the help of the first power supply 1a that provides necessary data to the second power supply 1b.

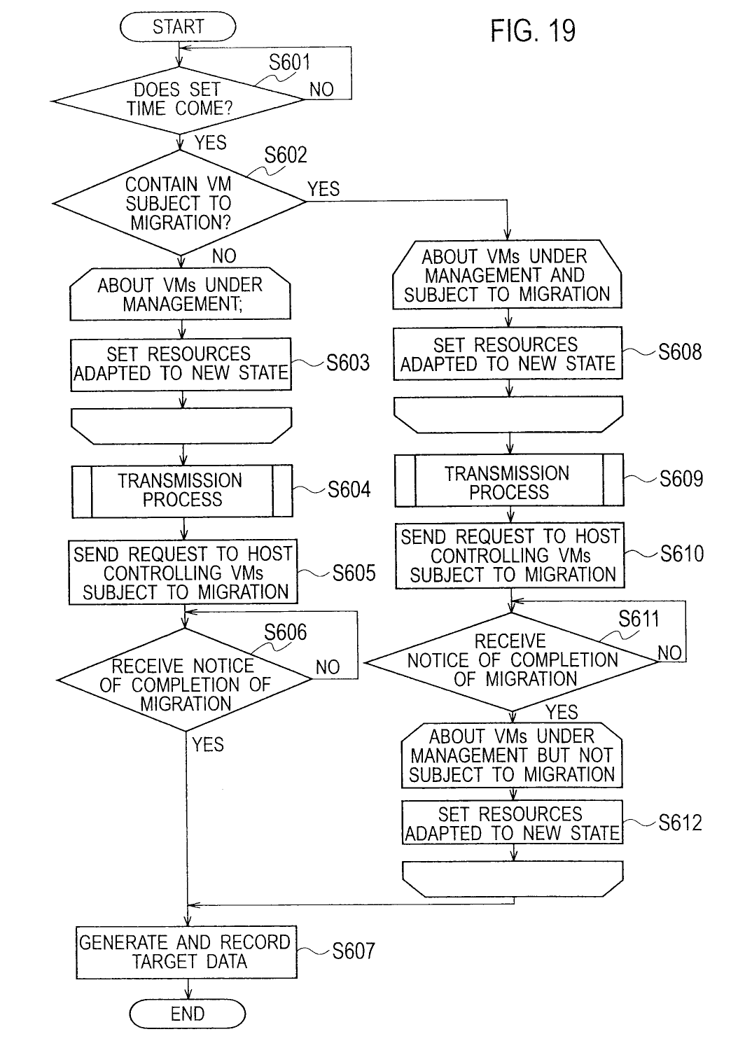

The process executed by the first power supply 1a will be described with reference to FIG. 19. While the process is similar to the process shown in FIG. 13, addition of a transmission process of the steps S604 and S609 differs from that in FIG. 13. The step S604 and the step S609 are executed before execution of the step S605 or the step S610 to send a request for migration. Further these processes are correspondent to the step S503 in FIG. 17.

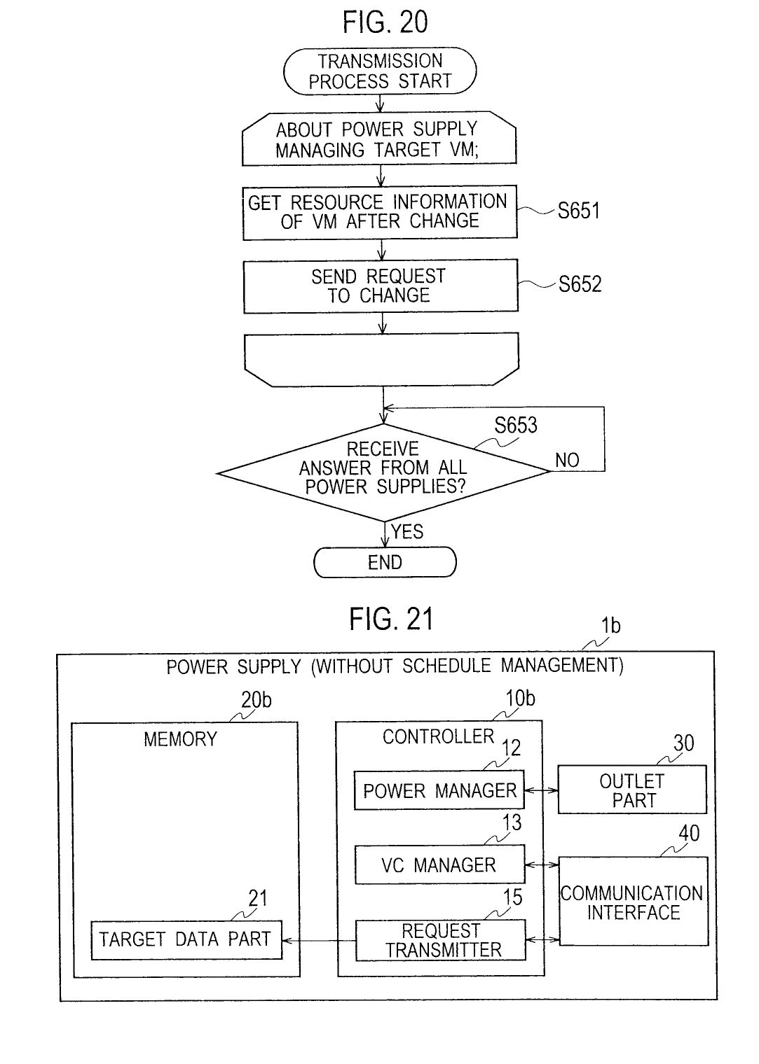

Details of the transmission process of the steps S604 and S609 will be described with reference to FIG. 20. The request transmitter 14 fetches information of resources to be allocated to the VCs in the new state about one of power supplies other than the first power supply 1a. These power supplies do not have the information at this stage. Then the request transmitter 14 in the step S652 generates data for the request from the fetched data and then sends the generated request to the power supply at issue through the communication interface 40. The steps S651 and S652 are repeatedly executed about the respective power supplies other than the first power supply 1a, and then these steps are completed.

After sending the request to all the power supplies, the request transmitter 14 in the step S653 waits replies therefrom.

When the request transmitter 14 determines that it finishes receiving answers from all the other power supplies, the process ends. Thereafter the process goes to the step S605 or the step 610 in FIG. 19.

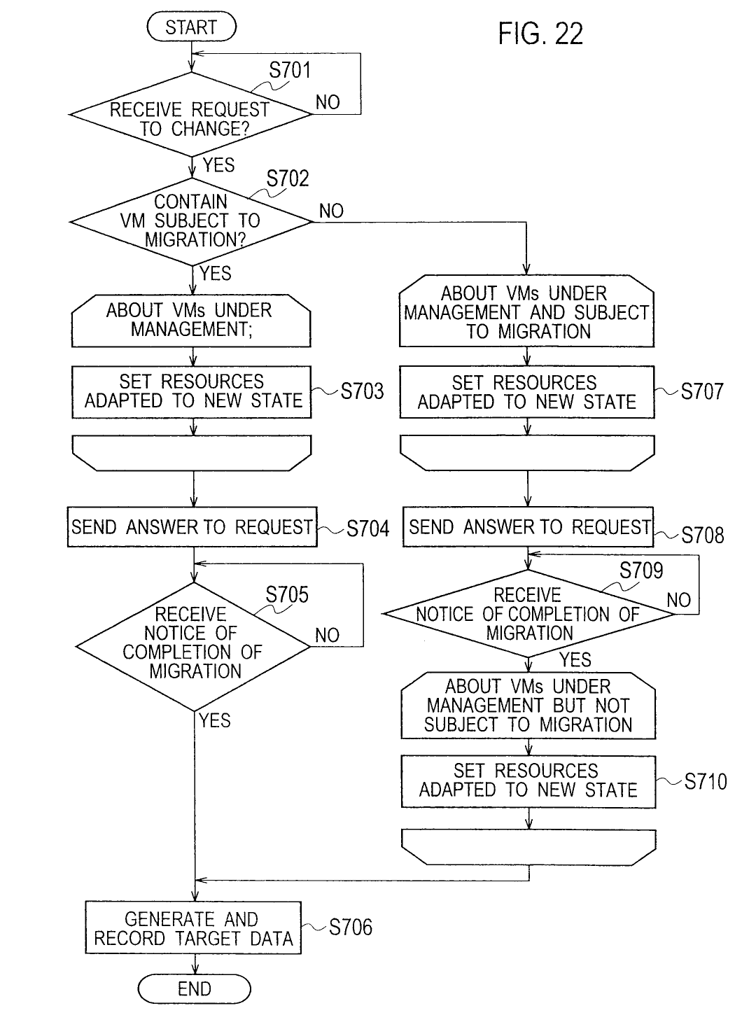

The process executed by the second power supply 1b will be described with reference to FIG. 22. While the process is similar to the process shown in FIG. 13, contents of the steps S701, S704 and S708 differs from those in FIG. 13.

The second power supply 1b in the step S701, instead of referring data in the memory 20b as with the first embodiment, receives a request from the first power supply 1a and is then triggered to start succeeding process.

The second power supply 1b in the step S704 or the step S708 sends a notice of completion of the step S703 or the step S707 to the first power supply 1a.

Thus the second power supply 1b, although it does not have the schedule data, executes the resource change process.

If there are three or more power supplies on a common network, only one power supply has the schedule data as with the aforementioned description, or alternatively two or more power supplies may have the identical schedule data, to execute a shut-down process.

Referring to FIG. 17, operation of the power supplies 1 and the hosts 2 at a time of migration will be described. First the first power supply 1a in the step S501 verifies the schedules and, when it is determined to be a set time for migration, the first power supply 1a in the step S502 sets resources adapted to the new state in regard to all the VMs under its management, where the VMs under its management are the VMs 3a, 3b running on the first host 2a.

The first power supply 1a in the step S503 sends a request to change resources to the second power supply 1b. The request, as described above, includes machine IDs of VMs subject to migration, host IDs as destination of the migration, and information about resources to be allocated to the migrated VMs, as well as machine IDs of VMs not subject to migration and information about resources allocated to the not-migrated VMs.

As receiving the request, the second power supply 1b in the step S504 sets resources adapted to the new state in regard to the fourth VM 3d. Then the second power supply 1b in the step S505 answers to the request.

As receiving the answer, the first power supply 1a in the step S506 sends a request for migration to the host 2c as the host 2c has the fourth VM 3d subject to migration running. The request includes a VM ID assigned to the fourth VM 3d and a host ID assigned to the first host 2a as a destination of the migration.

The third host 2c in the step S507 receives the migration request and then executes migration of the fourth VM 3d to the first host 2a.

Thereafter the first host 2a in the step S508 sends a notice of completion of migration to the first power supply 1a and in the step S509 sends a notice of completion of migration to the second power supply 1b.

After receiving the notice, the first power supply 1a in the step S510 checks up the latest state about the hosts and the VMs 3 and then generates target data. The generated data is recorded in the target data part 21 of the memory 20 of the first power supply 1a.

In parallel the second power supply 1b in the step S511 sets resources adapted to the new state in regard to all the VMs but the VM 3d subject to migration. The second power supply 1b in the step S512 records renewed target data in the target data part 21 of the memory 20 of the second power supply 1b.

Request transmission from the first power supply 1a may be batch processing but alternatively the requests may be properly divided into plural parts and then sent one by one. In the step S503 for example the first power supply 1a first sends information only about VMs resources of which are required to be changed before migration, and the rest of information about VMs resources of which are changed after migration may be postponed. Any other modification would occur.

The processes of the steps S511 and S512 may be triggered by a request from the first power supply 1a instead of the notice from the first physical host 2a.

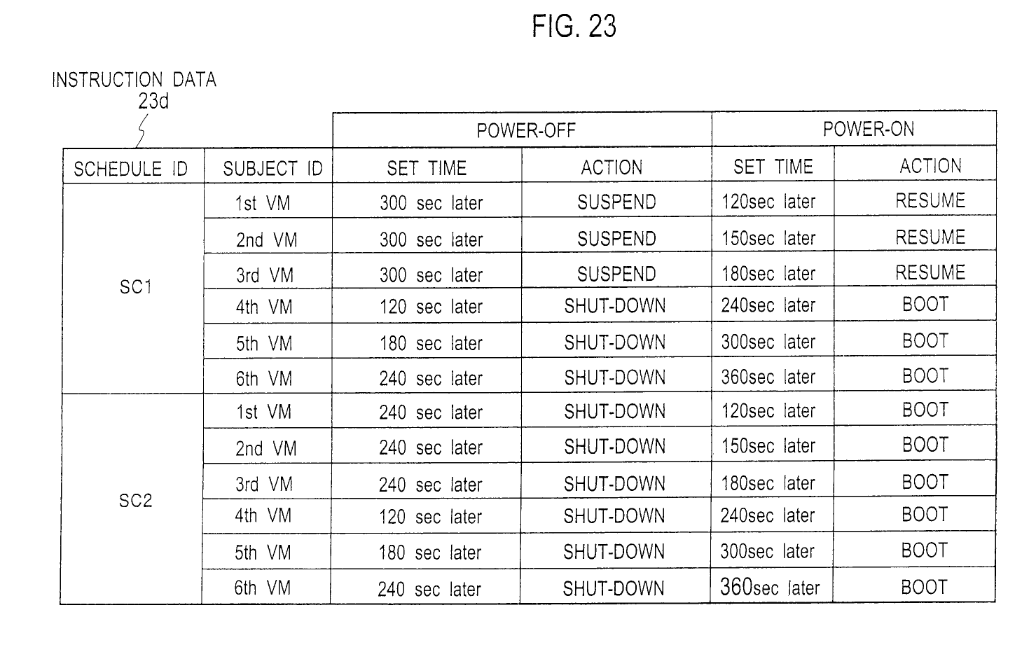

FIGS. 23 through 26 exemplify a third embodiment as another example of the aforementioned modifications. In the present embodiment, a power supply 1a does not wait responses of the other power supplies and sends commands in accordance with a predetermined timetable.

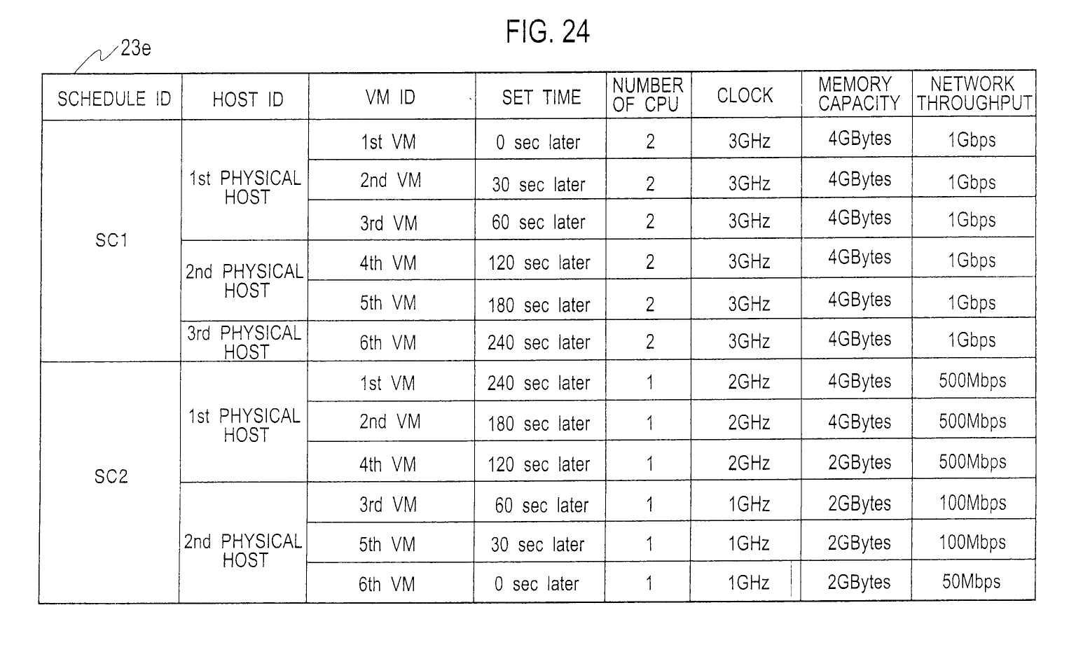

Referring to FIG. 23, the present embodiment utilizes an instruction data 23d with a timetable as to when each VM is suspended or shut down, instead of the instruction data 23a shown in FIG. 8. The timetable for example defines time delays after set times to execute suspend or shut-down, like as “300 seconds later”, “120 seconds later” Referring to FIG. 24, instruction data 23e about resources of the respective VMs 3 also include a timetable as to when migration is carried out.

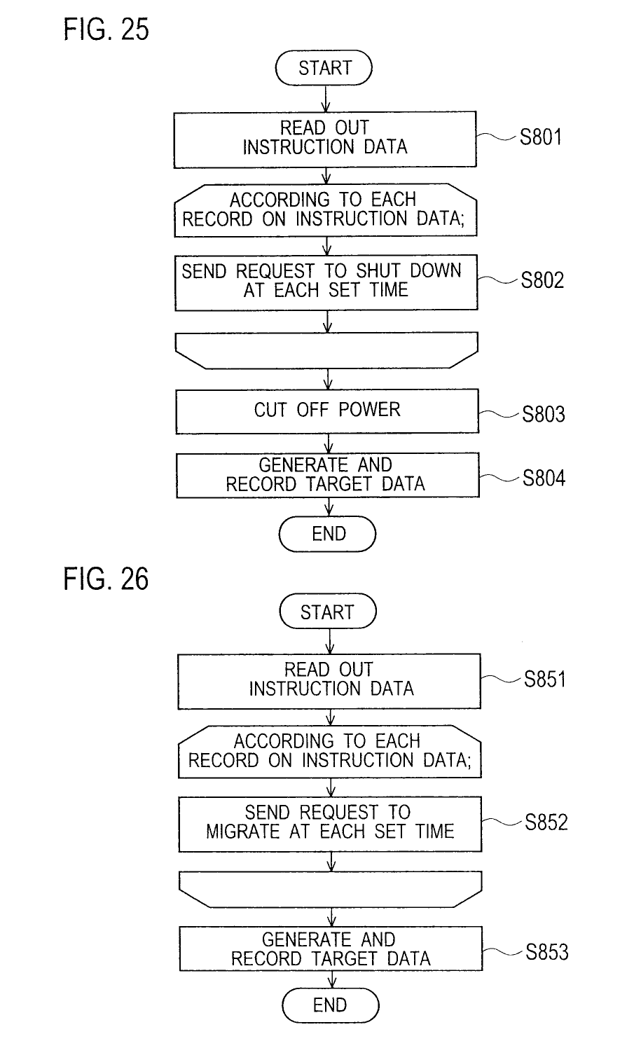

Referring to FIG. 25, the control device 11 of the power supply 1 in the step S801 reads out the instruction data 23d from the memory 20b. The control device 11 in the step S802 refers the timetable defined in the instruction data 23d to send requests to respective VMs.

After finishing the request transmission in accordance with the timetable, the control device 11 in the step S803 causes the outlet part 30 to cut off power supply.

Thereafter the control device 11 generates renewed target data in accordance with the new state and then records the generated data in the target data part 21 of the memory 20.

The process about migration will be described with reference to FIG. 26. The control device 11 of the power supply 1 in the step S851 reads out the instruction data 23e from the memory 20b. The control device 11 in the step S852 refers the set times about respective VMs to send request for migration to the VMs.

After finishing transmission of all the requests, the control device 11 in the step S853 generates renewed target data in accordance with the new state and then records the generated data in the target data part 21 of the memory 20.

The present embodiment also successfully shut down power supplies and host computers powered by the power supplies without unintentionally stopping VMs running on the hosts. Further, in the process, network traffic is relieved as the power supplies and the hosts do not handle the vast amount of communication related to shut-down.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A power supply used in combination with networked first and second hosts with a virtual machine implemented on the first host, comprising:
a memory;
an outlet part linked with outlets respectively supplying electricity to the hosts;
a communication interface linked with the hosts;
a controller linked with the memory, the outlet part and the communication interface;
a migration process located on the memory, wherein the migration process causes the communication interface to send a migration instruction to the first host, the migration instruction causing migration of the virtual machine to the second host; and
a shut-down process located on the memory, wherein the shut-down process causes the communication interface to send a shut-down instruction to the first host, the shut-down instruction causing shut-down of the first host.

2. The power supply of claim 1, further comprising:
an allocation process located on the memory, wherein the allocation process causes allocation of resources on the second host to the virtual machine.

3. The power supply of claim 2, wherein the allocation process causes the controller to calculate resource allocation adapted to a state after the migration.

4. The power supply of claim 1, further comprising:
a data located on the memory, the data including a procedure of the migration and the shut-down.

5. The power supply of claim 4, wherein the data further includes a timetable when the migration and the shut-down are executed.

6. The power supply of claim 1, further comprising:
a cut-off process located on the memory, wherein the cut-off process causes the outlet part to cut off the electricity to the first host.

7. A method of control of a power supply used in combination with networked first and second hosts with a virtual machine implemented on the first host, comprising:
allocating resources on the second host to the virtual machine;
sending a migration instruction to the first host, the migration instruction causing migration of the virtual machine from the first host to the second host; and
sending a shut-down instruction to the first host, the shut-down instruction causing shut-down of the first host.
